(19) United States
(12) Patent Application Publication
(10) Pub. No.: US 2003/0174598 A1
(43) Pub. Date: Sep. 18, 2003

(54) Optical disk apparatus

(75) Inventors: Sadayuki Takaba, Osaka (JP); Yasunori Kuwayama, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 10/368,632

(22) Filed: Feb. 20, 2003

(30) Foreign Application Priority Data
Feb. 21, 2002 (JP) P2002-044560

(51) Int. Cl. G11B 7/085

(52) U.S. Cl. 369/44.29; 369/53.18; 369/44.32; 369/30.16; 369/47.33

(57) ABSTRACT

When an optical disk apparatus 1 determines that it is timing of switching a recording layer for reading data from one recording layer to the other recording layer with respect to an optical disk 10, regardless of the amount of data stored in buffer memory 6 at this point in time, the optical disk apparatus 1 moves a pickup head 2 in a radial direction of the optical disk 10, and acquires a waveform of a tracking error signal, and also moves an objective lens in a direction going toward the optical disk 10, and acquires a waveform of a focus error signal, and readjusts tracking servo gain and focus servo gain based on these signal waveforms.

### BACKGROUND OF THE INVENTION

1. Field of the Invention

This invention relates to an optical disk apparatus for reading data recorded on an optical disk such as CD or DVD and outputting a reproduction signal based on the read data.

2. Description of the Related Art

In an optical disk apparatus for reading data recorded on an optical disk such as CD or DVD and outputting a reproduction signal (audio signal, video signal) conventionally, a position of a pickup head with respect to the optical disk set in the body was controlled by a tracking servo signal and a focus servo signal so that data from the optical disk can be read properly. The tracking servo signal is a signal for controlling the position so that a light beam (laser light) emitted from the pickup head is applied to the center of tracks formed on the optical disk. The focus servo signal is a signal for controlling the position so that a focal point of the light beam emitted from the pickup head is matched with a record surface of data in the optical disk.

By the way, after starting reproduction of the optical disk (after the completion of adjustments to the offset, balance and gain), reproduction environment has changed due to a change in temperature within the apparatus, a change in a reading position of data in the optical disk, and so on. The conventional optical disk apparatus adjusted offset, balance and gain used in generation of the tracking servo signal and the focus servo signal only once immediately after loading of the optical disk set in the body. Because of this, there was a problem that with respect to a change in the reproduction environment after starting reproduction, the offset, balance and gain cannot be held properly and the reproduction becomes unstable. Therefore, there was proposed an optical disk apparatus for preventing reproduction from becoming unstable by readjusting the offset, balance and gain during reproduction of the optical disk (JP-A-6-302104).

However, in this optical disk apparatus, the fact that a buffer for temporarily storing data read from the optical disk has filled was set to a condition for making readjustments to the offset, balance and gain. Because of this) the readjustments to the offset, balance and gain are not made unless the buffer fills. On the other hand, in reproduction of an optical disk having two recording layers of data, reproduction environment changes largely when the recording layer for reading data is switched from one layer to the other layer or after the completion of seek operation for jumping a track for reading data. Thus, timing in which the reproduction environment changes largely and timing in which the buffer fills are respectively independent timing, so that even when the reproduction environment changes, there were cases that the readjustments to the offset, balance and gain are not made, and the reproduction could not be prevented from becoming unstable.

### SUMMARY OF THE INVENTION

The invention has been made in view of the above circumstances, and therefore an object of the invention is to provide an optical disk apparatus for readjusting offset, balance and gain used in generation of a tracking servo signal and a focus servo signal in the case of switching a recording layer for reading data from one layer to the other layer at the time of reproduction of an optical disk having two recording layers of data or after the completion of seek operation for jumping a track for reading data regardless of whether or not a buffer for temporarily storing data read from the optical disk has filled.

In order to solve the object, an optical disk apparatus of the invention comprises the following configurations.

(1) In an optical disk apparatus comprising:

a pickup head for reading data recorded on an optical disk by applying a light beam to the optical disk and detecting reflected light from said optical disk,

buffer memory for storing data which the pickup head reads from the optical disk,

a reproducing part for outputting are production signal based on data stored in the buffer memory, and

a servo adjusting part for adjusting offset, balance and gain used in generation of a tracking servo signal and a focus servo signal supplied to the pickup head,

the servo adjusting part readjusts the offset, balance and gain in the case of switching a reading layer of data by the pickup head from one recording layer to the other recording layer when the optical disk is a two-layer disk having two recording layers of data.

In this configuration, the offset, balance and gain used in generation of a tracking servo signal and a focus servo signal supplied to the pickup head are readjusted in the case of switching a reading layer of data from one recording layer to the other recording layer in reproduction of an optical disk having two recording layers of data, for example, a DVD two-layer disk.

Therefore, with respect to a large change in reproduction environment caused by switching a reading layer of data from one recording layer to the other recording layer, the tracking servo signal and the focus servo signal can properly be held and the reproduction can surely be prevented from becoming unstable.

(2) In an optical disk apparatus comprising:

a pickup head for reading data recorded on an optical disk by applying a light beam to the optical disk and detecting reflected light from said optical disk,

buffer memory for storing data which the pickup head reads from the optical disk,

a reproducing part for out putting are production signal based on data stored in the buffer memory, and

a servo adjusting part for adjusting offset, balance and gain used in generation of a tracking servo signal and a focus servo signal supplied to the pickup head,

the servo adjusting part readjusts the offset, balance and gain in the case of the completion of seek operation for jumping a reading track of data in the optical disk.

In this configuration, the offset, balance and gain used in generation of a tracking servo signal and a focus servo signal supplied to the pickup head are readjusted in the case of the completion of seek operation for jumping a reading track of data.

Therefore, with respect to a large change in reproduction environment caused by jumping a reading track of data, the tracking servo signal and the focus servo signal can properly be held and the reproduction can surely be prevented from becoming unstable.

(3) Temperature detection means for detecting a temperature of the inside of the apparatus body is provided, and the servo adjusting part readjusts the offset, balance and gain in the case that a temperature of the inside of the apparatus body detected by the temperature detection means changes by a preset temperature or higher with respect to a temperature of the inside of the apparatus body detected by the temperature detection means at the time when the servo adjusting part has adjusted the offset, balance and gain previously.

In this configuration, the offset, balance and gain used in generation of a tracking servo signal and a focus servo signal supplied to the pickup head are readjusted in the case that a temperature of the inside of the apparatus body changes by a preset temperature (for example, 5° C.) or higher since the offset, balance and gain have been adjusted previously.

Incidentally, the case of changing by a preset temperature or higher called herein includes the cases that a temperature of the inside of the apparatus body not only increases but also decreases by the preset temperature or higher.

Therefore, with respect to a large change in reproduction environment associated with a change in temperature of the inside of the apparatus body, the tracking servo signal and the focus servo signal can properly be held and the reproduction can surely be prevented from becoming unstable.

### BRIEF DESCRIPTION OF THE DRAWINGS

FIG. 1 is a block diagram showing a configuration of an optical disk apparatus which is an embodiment of the invention;

FIG. 2 is a diagram describing a four-divided detector provided in a pickup head;

FIG. 3 is a diagram describing a tracking error signal;

FIG. 4 is a diagram describing a focus error signal;

FIG. 5 is a flowchart showing an operation of the optical disk apparatus which is the embodiment of the invention;

FIG. 6 is a flowchart showing an operation of the optical disk apparatus which is the embodiment of the invention;

FIG. 7 is a flowchart showing an operation of the optical disk apparatus which is the embodiment of the invention;

FIG. 8 is a flowchart showing an operation of the optical disk apparatus which is the embodiment of the invention; and

FIG. 9 is a flowchart showing an operation of the optical disk apparatus which is the embodiment of the invention.

### DETAILED DESCRIPTION OF THE PREFERRED EMBODIMENTS

An optical disk apparatus which is an embodiment of the invention will be described below.

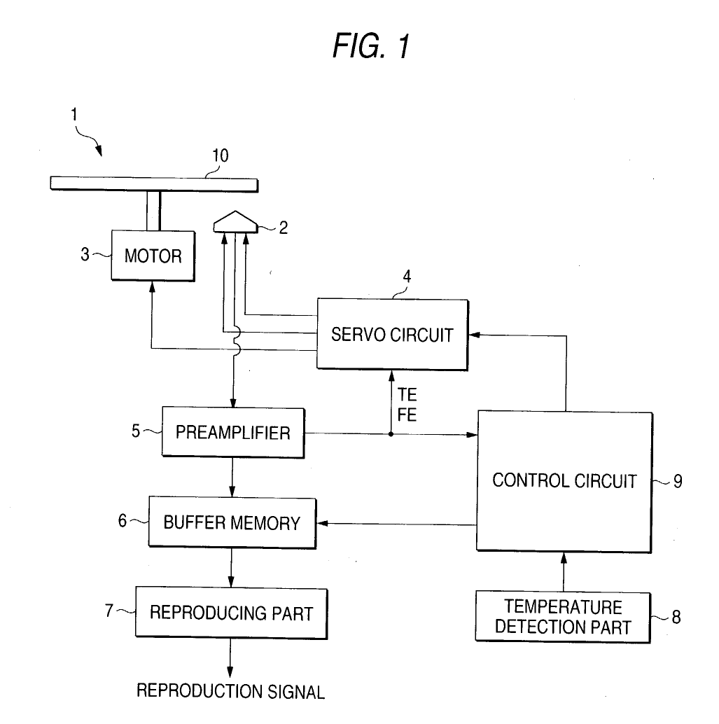

FIG. 1 is a block diagram showing a configuration of an optical disk apparatus which is an embodiment of the invention. An optical disk apparatus 1 of this embodiment comprises apickup head 2 for reading data stored in an optical disk (such as CD, DVD) 10, a motor 3 for rotating the optical disk 10 set in the body, and a servo circuit 4 for controlling a position of the pickup head 2 with respect to the optical disk 10 and a rotational speed of the optical disk 10 by the motor 3.

The servo circuit 4 performs tracking control for controlling movement in a radial direction (horizontal direction) of the optical disk 10 and focus control for controlling movement in a rotary shaft direction (vertical direction) of the optical disk 10 with respect to the pickup head 2.

An output of the pickup head 2 is inputted to a preamplifier 5. The preamplifier 5 inputs a tracking error signal (TE) and a focus error signal (FE) inputted from the pickup head 2 to the servo circuit 4. The tracking error signal is a signal indicating the deviation amount between the center of tracks of the optical disk 10 and an applied position of a light beam outputted from the pickup head 2. The focus error signal is a signal indicating the deviation amount between a record surface of data in the optical disk 10 and a focal position of the light beam outputted from the pickup head 2. Also, the preamplifier 5 records data read from the optical disk 10 in buffer memory 6. A reproducing part 7 reads out data stored in the buffer memory 6 and outputs a reproduction signal (audio signal, video signal) based on the data read out. A temperature detection part 8 detects a temperature of the inside of the temperature body, and a control part 9 controls an operation of the body.

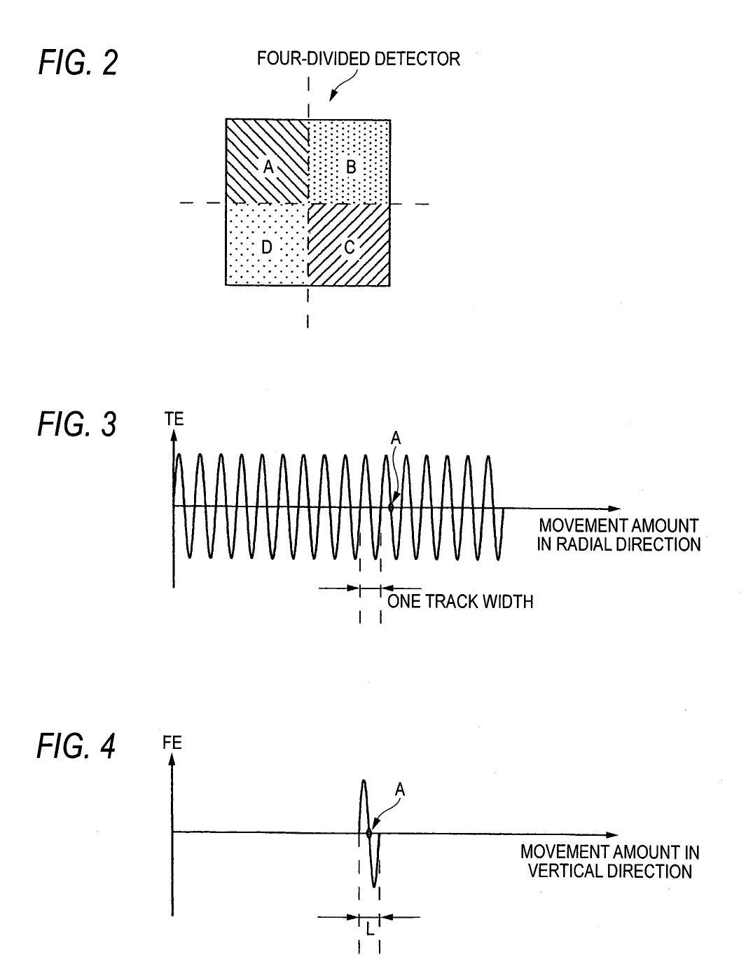

The tracking error signal and the focus error signal will briefly be described herein since they are well known. The tracking error signal is a differential signal of a detector (not shown) for a pair of side spots provided in the pickup head. Also, the focus error signal is a differential signal between power of reflected light detected in areas A and C and power of reflected light detected in areas B and D of a four-divided detector (see FIG. 2).

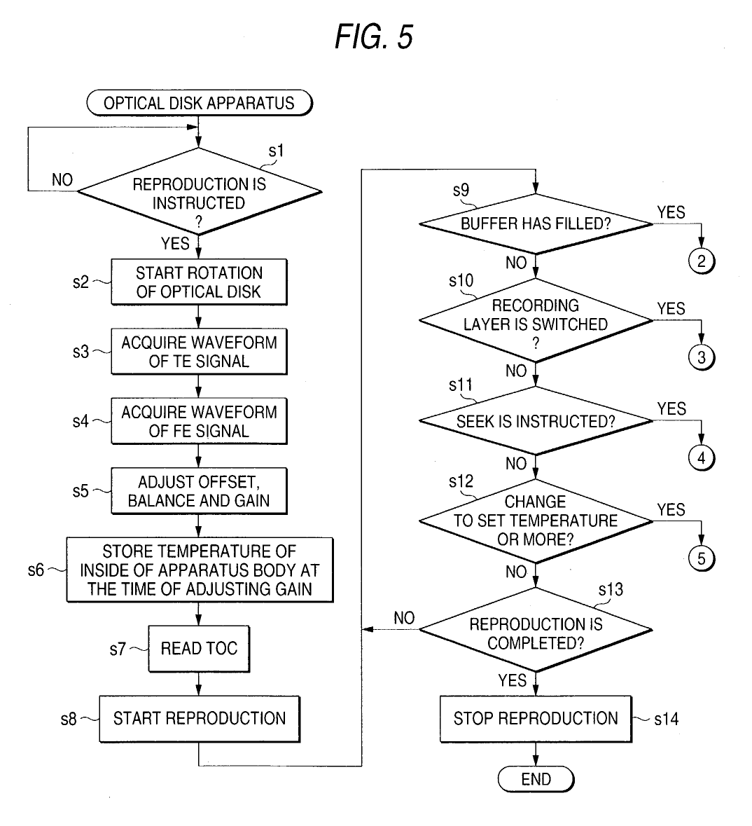

In the tracking error signal, a waveform shown in FIG. 3 is detected when an applied position of a light beam is moved in a radial direction of the optical disk 10. A point A shown in FIG. 3 indicates the time when the light beam is applied to the center of tracks. In the focus error signal, a waveform shown in FIG. 4 is detected when the pickup head 2 is moved in a vertical direction sandwiching a position in which focus of the light beam is achieved on a record surface of the optical disk 10. A point A shown in FIG. 4 indicates the time when the record surface of the optical disk 10 matches with the focus of the light beam. Tracking servo gain used in the case of generating a tracking servo signal is adjusted based on a size of amplitude of the tracking error signal shown in FIG. 3. Focus servo gain used in the case of generating a focus servo signal is adjusted based on a size of amplitude of the focus error signal shown in FIG. 4.

Next, an operation of the optical disk of this embodiment will be described. FIGS. 5 to 9 are flowcharts showing an operation of the optical disk apparatus of this embodiment. When reproduction of the optical disk 10 set in the body is instructed (Step s1), the optical disk apparatus 1 starts rotation of the optical disk 10 by the motor 3 (Step s2). Next, the pickup head 2 is moved in a radial direction of the optical disk 10 and a waveform of the tracking error signal shown in FIG. 3 is acquired (Step s3) and also an objective lens is moved in a direction going toward (or going away from) the optical disk 10 and a waveform of the focus error signal shown in FIG. 4 is acquired (Step s4).

The control part 9 adjusts tracking servo gain and focus servo gain based on the waveform of the tracking error signal acquired in Step s3 and the waveform of the focus error signal acquired in Step s4 (Step s5). At this time, offset and balance are also adjusted. Also, the control part 9 stores a temperature of the inside of the apparatus body detected by the temperature detection part 8 at this time as a temperature of the apparatus body at the time of adjusting the tracking servo gain and the focus servo gain (Step s6).

Thereafter, data recorded in a TOC area of the optical disk 10 is read (Step s7) and a reproduction operation of the optical disk 10 is started (Step s8). The reproduction operation is processing in which data which the pickup head 2 reads from the optical disk 10 is stored in the buffer memory 6 and the reproducing part 7 sequentially reads out data stored in the buffer memory 6 and converts the data into a reproduction signal (audio signal, video signal) to output the signal.

Incidentally, the optical disk apparatus 1 performs tracking control and focus control with respect to the pickup head 2 using the tracking error signal and the focus error signal, and the tracking servo gain and the focus servo gain adjusted in Step s5.

In the general optical disk apparatus 1, a reading speed of data from the optical disk 10 is higher than a reproducing speed in the reproducing part 7.

In the case of starting the reproduction operation in Step s8, the optical disk apparatus 1 determines \mathring{1} whether or not the buffer 6 has filled (Step s9), \mathring{2} whether or not it is timing of switching a recording layer for reading data from one recording layer to the other recording layer in the case that the optical disk is a disk having two recording layers of data (Step s10),

\mathring{3} whether or not a seek instruction for jumping a reproduction position of the optical disk were given (Step s11),

\mathring{4} whether or not a difference between the present temperature detected by the temperature detection part 8 and a temperature stored in the control part 9 at the time of adjusting offset, balance and gain reaches a preset temperature, for example, 5° C. (Step s12), and

\mathring{5} whether or not it is timing of completing reproduction (Step s13).

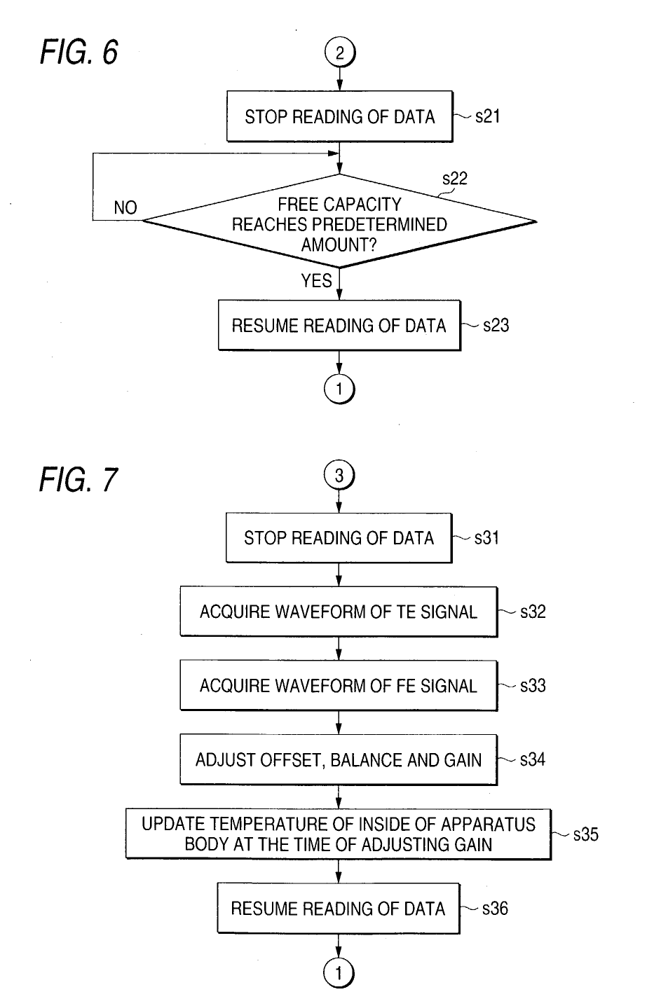

In the case of determining that the buffer 6 has filled in Step s9, the optical disk apparatus 1 performs processing shown in FIG. 6. The optical disk apparatus 1 stops reading of data from the optical disk 10 (Step s21). At this time, the optical disk apparatus 1 does not stop an output operation of the reproduction signal in the reproducing part 17. Also, rotation of the optical disk 10, tracking control based on the tracking error signal and focus control based on the focus error signal are not stopped. The optical disk apparatus 1 waits for a free capacity of the buffer memory 6 to reach a predetermined amount (Step s22), and resumes reading of data from the optical disk 10 stopped in Step s13 (Step s23), and returns to Step s9.

In the case of determining that it is timing of switching a recording layer for reading data from one recording layer to the other recording layer in Step s10, the optical disk apparatus 1 performs processing shown in FIG. 7. The optical disk apparatus 1 stops reading of data by the pickup head 2 (Step s31) and also moves the pickup head2 in a radial direction of the optical disk 10 and acquires a waveform of the tracking error signal shown in FIG. 3 (Step s32) . Also, the pickup head 2 is moved in a direction going toward (or going away from) the optical disk 10 and a waveform of the focus error signal shown in FIG. 4 is acquired (Step s33) . The processing of Steps s32 and s33 is the same processing as that of s3 and s4 described above, respectively but the operation differs in that the pickup head 2 switches the recording layer from one recording layer to the other recording layer. In the case of completing the processing of Steps s32 and s33 described above, the optical disk apparatus 1 readjusts tracking servo gain and focus servo gain based on the waveform of the tracking error signal acquired in Step s32 and the waveform of the focus error signal acquired in Step s33 (Step s34). At this time, offset and balance are also adjusted. In tracking control and focus control after this, the tracking servo gain and the focus servo gain readjusted in Step s34 are used.

Further, the optical disk apparatus 1 updates a temperature of the apparatus body at the time of adjusting the tracking servo gain and the focus servo gain stored in the control part 9 to a temperature detected by the temperature detection part 8 at this point in time Step (s35), and resumes reading of data by the pickup head 2 in s36 and thereafter, returns to Step s9.

Incidentally, while the processing of Steps s31 to s36 shown in FIG. 7 is performed, the reproducing part 7 also reads out data stored in the buffer memory 6 and outputs a reproduction signal based on the data read out herein.

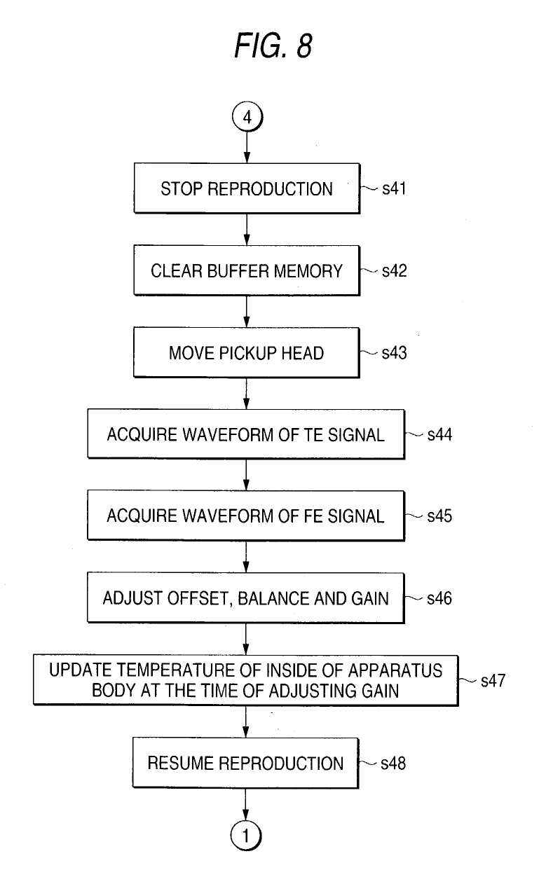

Also, in the case of determining that a seek instruction for jumping a reproduction position of the optical disk 10 were given in Step s11, the optical disk apparatus 1 performs processing shown in FIG. 8. The optical disk apparatus 1 stops a reproduction operation (Step s41) and also clears data stored in the buffer memory 6 (Step s42). At this time, the optical disk apparatus 1 does not stop rotation of the optical disk 10.

The optical disk apparatus 1 moves the pickup head 2 to an instructed track (Step s43). After the completion of movement of the pickup head 2, the optical disk apparatus 1 moves the pickup head 2 in a radial direction of the optical disk 10 and acquires a waveform of the tracking error signal shown in FIG. 3 (Step s44) and also moves an objective lens in a direction going toward (or going away from) the optical disk 10 and acquires a waveform of the focus error signal shown in FIG. 4 (Step s45). The processing of Steps s44 and s45 is the same processing as that of Steps s3 and s4 described above, respectively. In the case of completing the processing of Steps s44 and s45 described above, the optical disk apparatus 1 readjusts tracking servo gain and focus servo gain based on the waveform of the tracking error signal acquired in s44 and the waveform of the focus error signal acquired in Step s45 (Step s46) . At this time, offset andbalance are also adjusted. In tracking control and focus control after this, the tracking servo gain and the focus servo gain readjusted in Step s46 are used. Further, the optical disk apparatus 1 updates a temperature of the apparatus body at the time of adjusting the tracking servo gain and the focus servo gain stored in the control part 9 to a temperature detected by the temperature detection part 8 at this point in time (Step s47), and resumes the reproduction operation in Step s48 and thereafter, returns to Step s9.

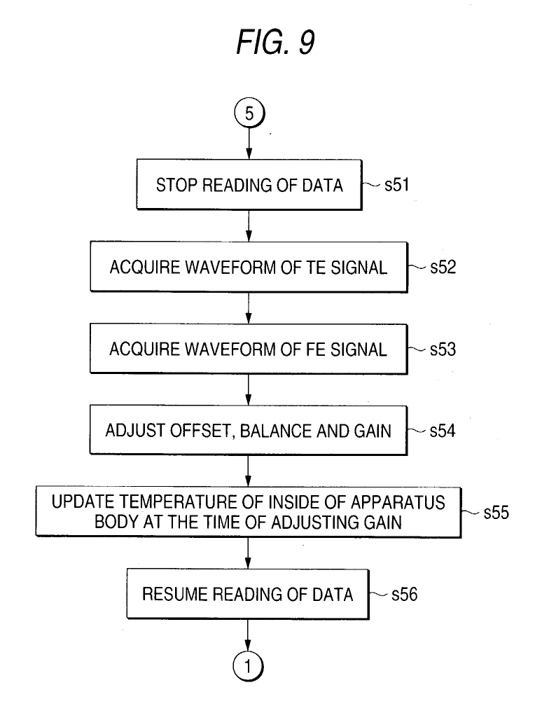

Also, in the case of determining that a temperature difference between the present temperature detected by the temperature detection part 8 and a temperature of the apparatus body at the time of adjusting the tracking servo gain and the focus servo gain stored in the control part 9 reaches a preset temperature, for example, 5° C. in Step s12, the optical disk apparatus 1 performs processing shown in FIG. 9.

Incidentally, the optical disk apparatus 1 performs the processing shown in FIG. 9 not only when the present temperature detected by the temperature detection part 8 increases by the set temperature or higher with respect to a temperature of the apparatus body at the time of adjusting the tracking servo gain and the focus servo gain stored in the control part 9 but also when the present temperature decreases by the set temperature or higher.

The optical disk apparatus 1 stops reading of data by the pickup head 2 (Step s51) and moves the pickup head 2 in a radial directionof the optical disk 10 and acquires awaveform of the tracking error signal shown in FIG. 3 (Step s52) and also moves an objective lens in a direction going toward (or going away from) the optical disk 10 and acquires a waveform of the focus error signal shown in FIG. 4 (Step s53). The processing of Steps s52 and s53 is the same processing as that of Steps s3 and s4 described above, respectively.

In the case of completing the processing of steps s52 and s53 described above, the optical disk apparatus 1 readjusts tracking servo gain and focus servo gain based on the waveform of the tracking error signal acquired in Step s52 and the waveform of the focus error signal acquired in Step s53 (Step s54) . At this time, offset and balance are also adjusted. In tracking control and focus control after this, the tracking servo gain and the focus servo gain readjusted in Step s54 are used.

Further, the optical disk apparatus 1 updates a temperature of the apparatus body at the time of adjusting the tracking servo gain and the focus servo gain stored in the control part 9 to a temperature detected by the temperature detection part 8 at this point in time (Step s55), and resumes reading of data by the pickup head 2 in s56 and thereafter, returns to s9.

Incidentally, while the processing of Steps s51 to s56 shown in FIG. 9 is performed, the reproducing part 7 also reads out data stored in the buffer memory 6 and outputs a reproduction signal based on the data read out herein.

Thus, the optical disk apparatus 1 of this embodiment readjusts the tracking servo gain and the focus servo gain in the case of switching a reading layer of data from one layer to the other layer at the time of reproduction the optical disk having two recording layers of data, after the completion of seek operation for jumping a track for reading data, and further in the case that a temperature difference between a temperature of the apparatus body at the time of previous adjustments to the tracking servo gain and the focus servo gain and the present temperature of the apparatus body changes by apreset temperature or higher. Therefore, with respect to a large change in reproduction environment, the tracking servo signal and the focus servo signal can properly be held and the reproduction can surely be prevented from becoming unstable.

As described above, according to the invention, with respect to a large change in reproduction environment caused by switching a reading layer of data from one recording layer to the other recording layer, offset, balance and gain used in generation of a tracking servo signal and a focus servo signal supplied to a pickup head are readjusted surely, so that reproduction can be prevented from becoming unstable.

Also, with respect to a large change in reproduction environment caused by jumping a reading track of data, offset, balance and gain used in generation of a tracking servo signal and a focus servo signal supplied to apickup head are readjusted surely, so that reproduction can be prevented from becoming unstable.

Further, with respect to a large change in reproduction environment associated with a change in temperature of the inside of the apparatus body, offset, balance and gain used in generation of a tracking servo signal and a focus servo signal supplied to a pickup head are readjusted surely, so that reproduction can be prevented from becoming unstable.

What is claimed is:

1. An optical disk apparatus comprising:
a pickup head for reading data recorded on an optical disk by applying a light beam to the optical disk and detecting reflected light from said optical disk;
buffer memory for storing data which the pickup head reads from the optical disk;
are producing part for outputting are production signal based on data stored in the buffer memory;
a servo adjusting part for adjusting offset, balance and gain used in generation of a tracking servo signal and a focus servo signal supplied to the pickup head;
a temperature detector for detecting a temperature of the inside of the apparatus body, and the servo adjusting part readjusts the offset, balance and gain in the case of switching a reading layer of data by the pickup head from one recording layer to the other recording layer when the optical disk is a two-layer disk having two recording layers of data, the case of the completion of seek operation for jumping a reading track of data in the optical disk, and the case that a temperature of the inside of the apparatus body detected by the temperature detector changes by a preset temperature or higher with respect to a temperature of the inside of the apparatus body detected by the temperature detector at the time when the servo adjusting part has adjusted the offset, balance and gain previously.

2. An optical disk apparatus comprising:
a pickup head for reading data recorded on an optical disk by applying a light beam to the optical disk and detecting reflected light from said optical disk;
a buffer memory for storing data which the pickup head reads from the optical disk;
are producing part for outputting are production signal based on data stored in the buffer memory; and
a servo adjusting part for adjusting offset, balance and gain used in generation of a tracking servo signal and a focus servo signal supplied to the pickup head, characterized in that the servo adjusting part readjusts the offset, balance and gain in the case of switching a reading layer of data by the pickup head from one recording layer to the other recording layer when the optical disk is a two-layer disk having two recording layers of data.

3. An optical disk apparatus comprising:
a pickup head for reading data recorded on an optical disk by applying a light beam to the optical disk and detecting reflected light from said optical disk;
a buffer memory for storing data which the pickup head reads from the optical disk,
are producing part for outputting are production signal based on data stored in the buffer memory; and
a servo adjusting part for adjusting offset, balance and gain used in generation of a tracking servo signal and a focus servo signal supplied to the pickup head,
wherein the servo adjusting part readjusts the offset, balance and gain in the case of the completion of seek operation for jumping a reading track of data in the optical disk.

4. The optical disk apparatus as defined in claim 2, further comprising a temperature detector for detecting a temperature of the inside of the apparatus body,
wherein the servo adjusting part readjusts the offset, balance and gain in the case that a temperature of the inside of the apparatus body detected by the temperature detector changes by a preset temperature or higher with respect to a temperature of the inside of the apparatus body detected by the temperature detection means at the time when the servo adjusting part has adjusted the offset, balance and gain previously.
